(19) United States
(12) Patent Application Publication
(10) Pub. No.: US 2019/0193359 A1
(43) Pub. Date: Jun. 27, 2019

(54) PRESS BAG SUPPORT SYSTEMS, APPARATUS AND METHODS

(71) Applicants: Dale Wettlaufer, Sarasota, FL (US); Eric Wettlaufer, Buffalo, NY (US)

(72) Inventors: Dale Wettlaufer, Sarasota, FL (US); Eric Wettlaufer, Buffalo, NY (US)

(21) Appl. No.: 16/230,327

(22) Filed: Dec. 21, 2018

Related U.S. Application Data
(60) Provisional application No. 62/610,222, filed on Dec. 24, 2017.

(51) Int. Cl. B30B 9/26; A23L 2/04; B30B 9/06

(52) U.S. Cl. CPC B30B 9/26; A23V 2002/00; B30B 9/06; A23L 2/04

(57) ABSTRACT

A reusable, flexible outer support bag for supporting a disposable filter bag removably placed inside the outer support bag during a juice pressing operation which applies pressure against the outer support bag and inner filter bag, the outer support bag having one or more juice outlets whereby juice pressed from a foodstuff located inside said disposable filter bag passes through the filter bag and is directed out of said outer support bag through the juice outlets, the outer support bag providing support to the filter bag and preventing rupture thereof during the application of pressure.

### BACKGROUND OF THE INVENTION

The present invention relates to apparatus and methods for making freshly squeezed juice from non-citrus fruits and vegetables. More particularly, the invention relates to cold press juice extraction without the application of heat, and even more specifically it relates to a method of extracting juice via batch pressing using a reusable outer press bag that supports an inner disposable press bag.

The process of making so-called “Cold Pressed” juice essentially involves three distinct operations:

1. Shredding (or grinding) and depositing the raw produce to be juiced in a liquid permeable container.

2. Applying pressure to the shredded produce to drive the juice out of the produce.

3. Filtering or separating the remaining solids portion of the produce from the liquid portion of the juice, wherein the coarse and fine insoluble solids in the juice are separated from the liquid portion.

An example of a typical machine apparatus for making cold-pressed juice is found in U.S. Pat. No. 5,031,524 entitled Fruit and Vegetable Juice Press Assembly which shows the configuration and implementation of a cloth press bag in which the cloth open-top press bag hangs vertically from its upper opening, with a sewn seam sealing the bottom and sides of the bag itself. The '524 patent concerns itself most closely with construction of, and method of support for, the pressing bag used in such a juice press.

While others have mentioned in passing the possibility of using a “disposable bag”, none have been successful at designing a system for using a disposable bag that accomplishes the following desirable characteristics:

1. Withstands the pressing pressure without rupturing;

2. Has a permeability which efficiently passes liquid to the juice catch basin but not solids; and

3. Does not allow escape of the produce through the open top during pressing.

U.S. Pat. No. 2,087,435 to Hubbert discloses a juice press assembly which uses a press bag. Hubbert teaches a surrounding chamber to support the bag on the vertical sides and bottom, one of said vertical sides of the chamber moveable towards the opposite side to create a compression force against the material in the bag. It also teaches through-holes in the chamber walls for juice to exit from the bag chamber. It also teaches closing and sealing of the top of the bag with a mechanism to prevent shredded material in the bag from exiting during the pressing operation. This would force the bag to withstand the elevated pressures of compression which would result from the pressure rising too high too fast, for instance if the bag pores plugged during pressing.

U.S. Pat. No. 5,031,524 by Wettlaufer teaches the use of an open top bag which remains open during the pressing operation, thus relieving stress from the bag itself, should pressure climb too high too fast during pressing. However, Wettlaufer '524 does not show a means of supporting the bag on the edges and along the bottom of the bag. This would necessitate a strong bag capable of taking the full force of the compression.

### SUMMARY OF THE INVENTION

Although many attempts have been made to grind the produce and then pour the slurry over a filter of some kind, these attempts have been met with limited success, due primarily to the small size of the insoluble particles which tend to clog most filters by plugging the holes in the filter material almost immediately. A much better approach has been found to be to contain the solids in a filter bag and to perform a pressing operation whereby the solids are retained in a bag during pressing so that they never make it into the juice in the first place. When the pressing operation is executed correctly, the filter bag approach is more effective and more efficient with far lower juice losses.

It is known to use a simple woven foraminous cloth bag wherein the shredded produce is placed. Pressure is applied against the exterior of the bag and the pressed juice escapes through the small holes in the bag while preventing larger particles from exiting the bag with the juice.

Due to sanitary considerations, it has been found that a cloth bag strong enough to stand up to the forces of the pressing operation makes it difficult to sanitize due to particles and microbes locating deep within the woven fibers. Disease causing microbes in the bag can transfer to the juice leading to shortened shelf life at the least, and at worst bodily harm to the consumer. The cloth fibers can also retain cleaning chemicals that are difficult to rinse out, causing flavor contamination as well as potential health hazards.

For the above reasons, some local health departments in the U.S. no longer allow cloth bags to be used for commercial juice production, and this has posed a dilemma for commercial juice makers. One solution to the problem is to use metallic screens but these provide poor results due to the small size of holes of the screen necessary to hold back the fine particles of the mash. These holes also plug quickly, as compared to the cloth bag in that the surface area presented by a cloth bag tends to plug less quickly and to release the pressed “cake” more easily than a rigid screen. Cloth is flexible and clogs tend to continue to be dislodged as the cloth is stretched and flexed.

One potential solution is to replace the cloth with a substitute paper or spun polymer. The paper or spun polymer can be made much less expensively than cloth and enable single-use and discard, similar to a paper filter used in a drip coffee maker. The paper or spun polymer liner is used once and then discarded. In order to keep the price low, the filter material used must be thin which unfortunately also makes it weak. While not an issue for a drip coffee maker, a bag made of this common filter material is not capable by itself of withstanding the large forces involved in juice pressing. Hence, some form of support is required to keep the bag from bursting. Ideally, the support for the disposable bag, whatever its design, should be easily cleanable using commonly accepted sanitation methods.

In an embodiment, support for the filter is provided by a strong backing surface positioned to abut and support the filter element during pressing. In order to allow the juice contained in the shredded organic material to exit to a container, thin grooves or small holes, usually smaller than 0.0625 inches across, are provided in the backing surface. The strong backing surface thus helps prevent the inherently weak filter material from rupturing.

The current inventors have discovered and employed several unique techniques or methods to support a paper press bag which can be summarized as follows:

1. Thru-holes or thru-slots in the rigid pressing chamber walls.

2. Profiling on the flat inside rigid walls of the pressing chamber.

3. Construction of a chamber made from metal basket material.

4. Adding profile to the bag itself by simply crimping or folding the bag to make raised ridges.

5. Use of separate removable profiled pieces resembling combs inserted between the chamber wall and bag.

6. Use of a metal wire backing plate commercially called “wedge wire”.

7. Insertion of a woven screen material between the paper bag and the chamber wall.

Each of the above previous methods have a disadvantage in common: all involve some sort of rigid support pieces, all of which must be removed and cleaned after use, which can be cumbersome and tedious. Another disadvantage is the necessity to make all the rigid chamber pieces fit tightly together which requires care and alignment. If not aligned perfectly the paper liner may insert itself in any crack and extrude and rupture.

The present invention seeks to eliminate almost all of the rigid chamber pieces, and replace them with one flexible external support bag, inexpensively molded out of silicone or natural rubber, which itself is lined with narrow grooves to allow juice escape to either a lower spout or through holes in the sides of the support bag.

In one preferred embodiment, a flexible yet strong outer support bag made of silicone or natural rubber is provided which may be molded in the general shape of a funnel with a flexible spout at its lowest edge. In one embodiment, juice directing elements may be provided in the form of vertically extending linear or non-linear (e.g., zig-zag) grooves formed on the support bag inner surface whereby the grooves provide an open space for the juice to pass as from the inner bag filter material while the surfaces at the periphery of the grooves provide sufficient support to prevent the inner filter bag from rupturing due to the pressing forces during a juicing operation. The grooves further direct and channel the juice down to the spout where it exits the outer support bag. In an alternate embodiment, the grooves and/or spout may be dispensed with and a plurality of small through-holes may be punched or molded in the sides and or bottom of the outer support bag.

Additional objects, advantages and novel aspects of the present invention will be set forth in part in the description which follows, and will in part become apparent to those in the practice of the invention, when considered with the attached figures.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is a perspective view of an embodiment of outer support bag with internal grooves and spout;

FIGS. 2 and 3 is a top view and a bottom view thereof, respectively;

FIGS. 4 and 5 is side view and an edge view thereof, respectively;

FIG. 6 is a top plan view showing the support bag, press platens, and disposable liner bag;

FIGS. 7a and 7b is a perspective view of an embodiment of support bag with spout in the open position and the closed position prior to pressing, respectively;

FIGS. 8a-8d illustrate four steps of the support bag in use; and

FIGS. 9a-9d are perspective views of an alternate embodiment of the support bag with through-holes which may be in combination with or in place of grooves and/or spout.

### DETAILED DESCRIPTION OF PREFERRED EMBODIMENTS

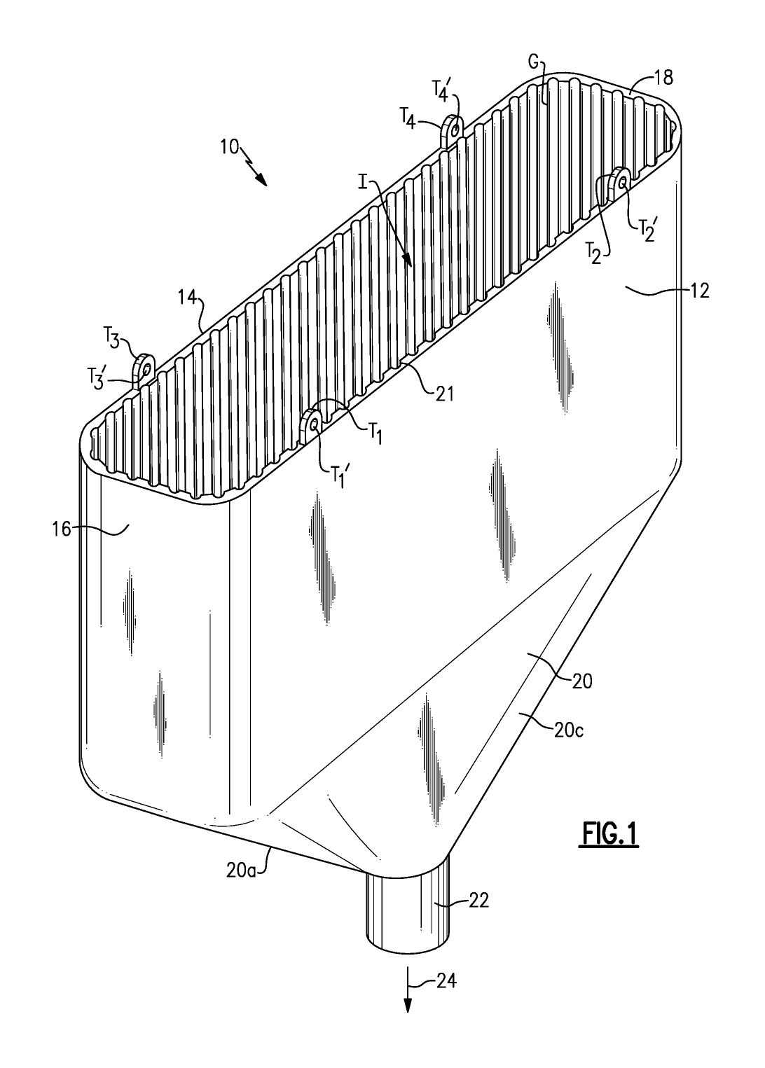

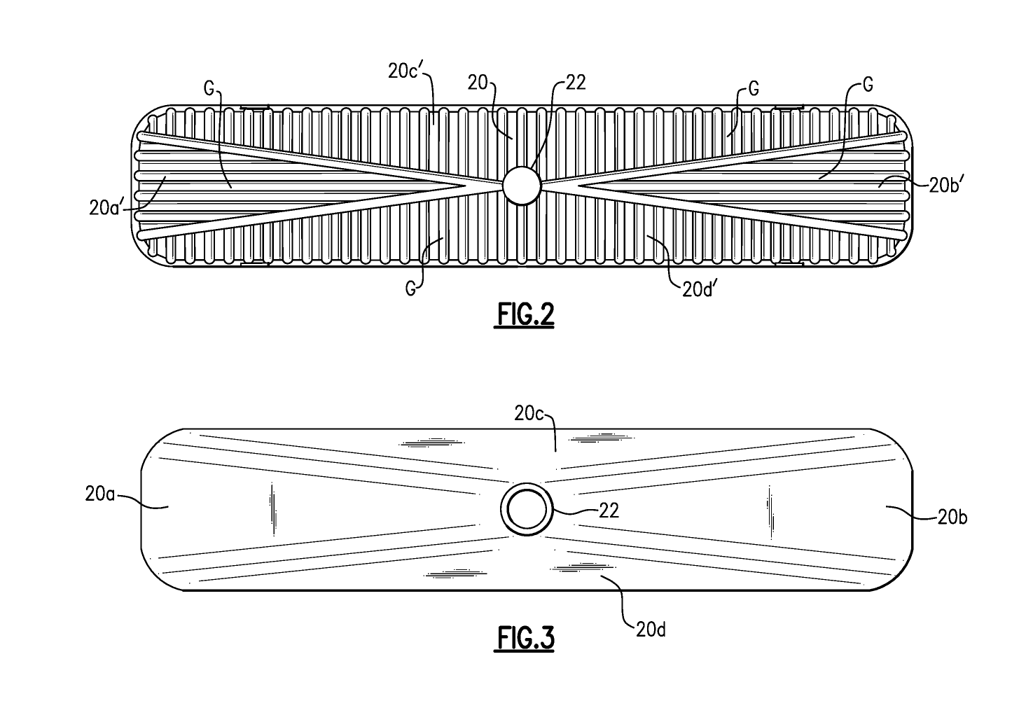

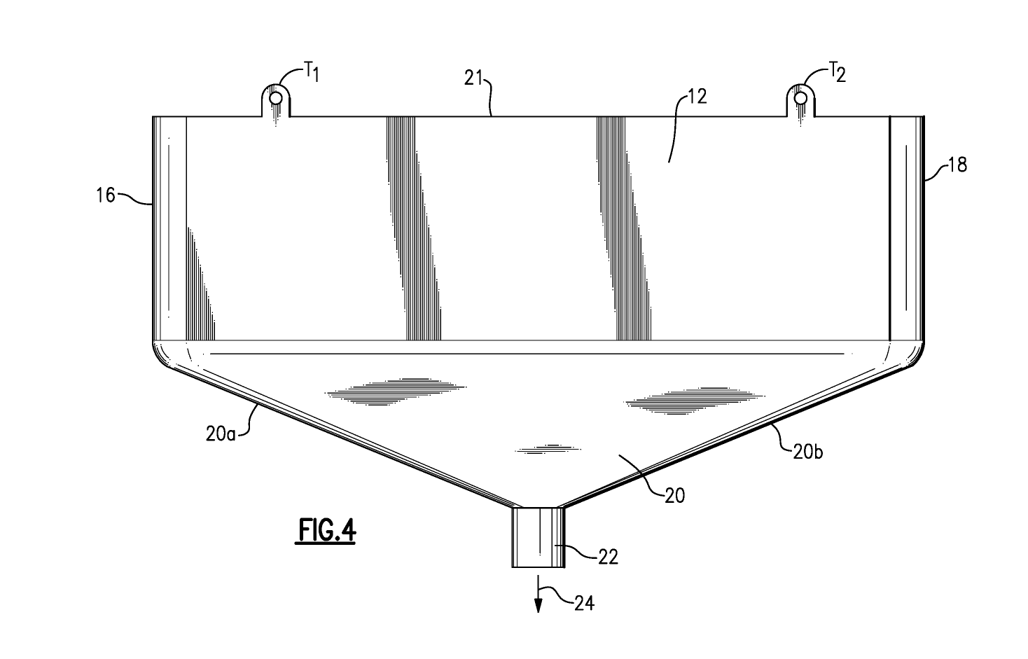

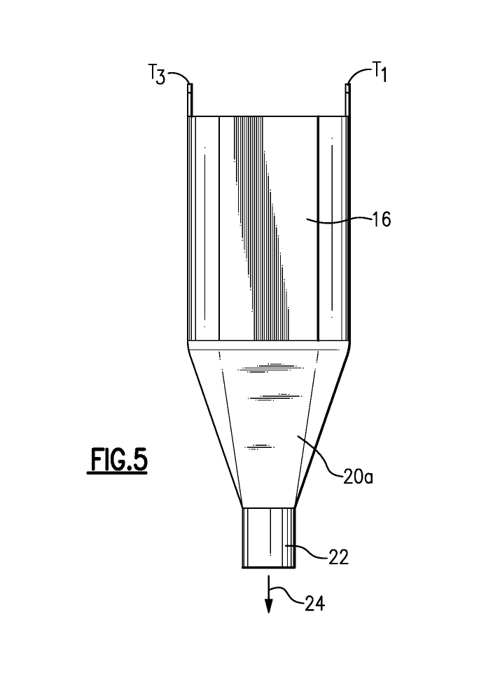

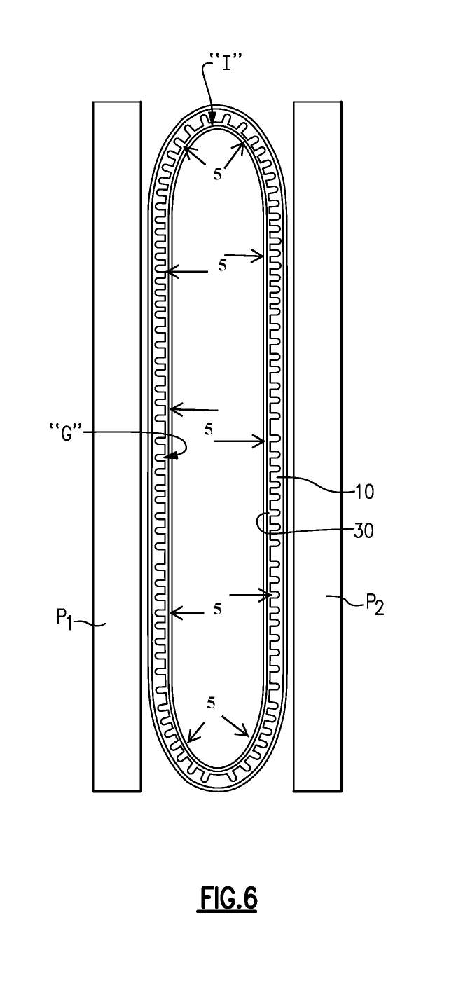

Referring to FIGS. 1 through 5, one possible embodiment of an outer support bag 10 is provided which is preferably made from a flexible yet durable material such as a silicone or natural rubber although other appropriate materials may be used as desired. Support bag 10 may be provided in a variety of shapes and sizes as desired. In FIGS. 1-5, support bag 10 is generally rectangular shaped with opposite first and second side walls 12 and 14, respectively, opposite first and second end walls 16 and 18, respectively, and a bottom wall 20 all defining an open top 21 and interior space “I”. Bottom wall 20 may further be configured with opposite end walls 20a and 20b and opposite side walls 20c and 20d. An outlet which may be in the form of a spout 22 may be provided at bottom wall 20 wherethrough liquids may exit support bag 10 as indicated by arrow 24.

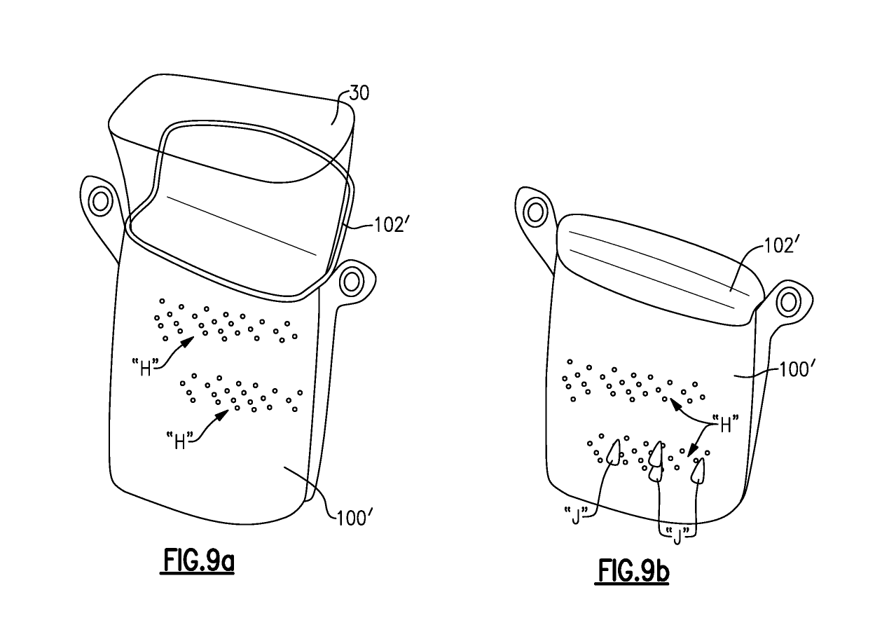

In an embodiment, one or more bag attachment mechanisms may be provided for removably attaching the support bag to a pressing apparatus such as between pressing plates P1 and P2 seen in FIG. 8. Pressing plates P1 and P2 (or other apparatus as may exist on the particular juicing apparatus utilized), may include projections such as pins P1′ and P2′ over which openings T1′ and T3′ in tabs T1 and T3 may be removably pressed over (together with the other tab/pin pairs that are out of view in FIG. 8).

While support bag 10 may optionally be smooth on the outside, the inwardly facing surfaces of one or more of the walls 12, 14, 16, 18 and 20 defining interior “I” may be provided with juice directing elements such as grooves “G” arranged so as to channel juice downwards toward an outlet such as a lower spout 22 where the juice can exit support bag 10. In the preferred embodiment, grooves “G” are about 0.0625″ wide and may be of any depth or length. It has been found that this width dimension is sufficient to support most filter media without bursting under pressure.

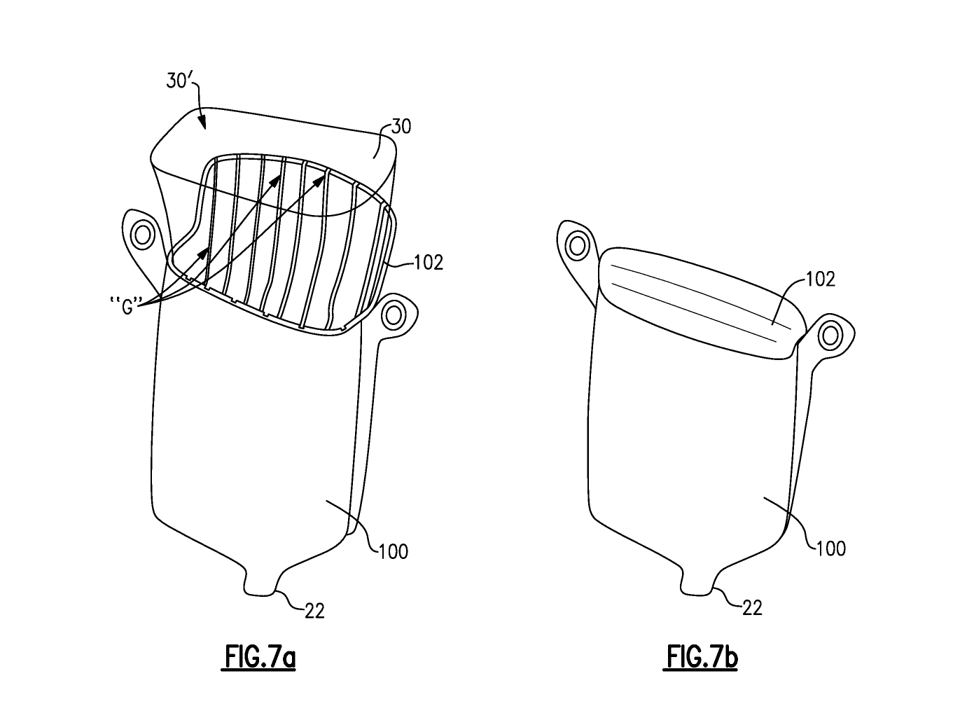

As seen in FIG. 6, support bag 10 with inwardly facing grooves “G” is removably located between pressing platens or plates P1 and P2 with filter bag 30, which may be made of paper or spun polymer, removably placed inside interior “I” of outer support bag 10. The size of filter bag 30 is preferably at least as voluminous as the outer support bag 10 so that filter bag 30 is supported on all sides by outer support bag 10. Small arrows 5 show the direction of juice flow through filter bag 30 during pressing as the platen P2 is moved towards the opposite platen P1 which thereby compresses everything located in the bags 10 and 30.

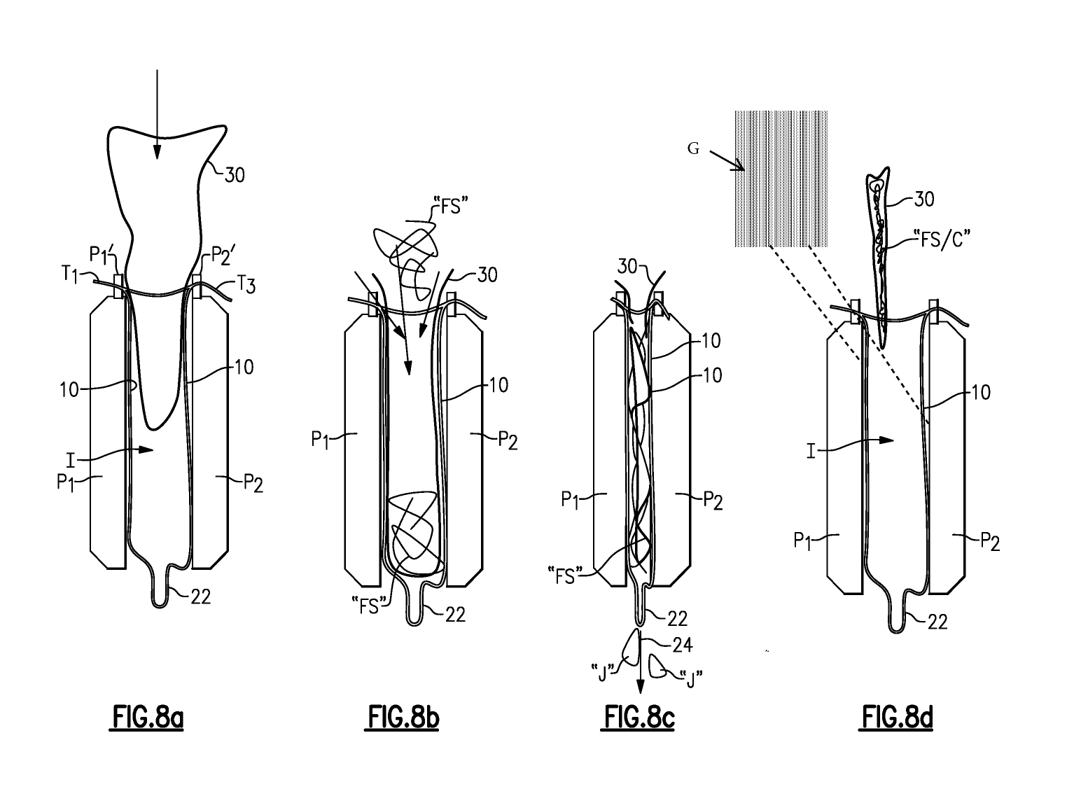

As seen in FIGS. 7a and 7b, another potential embodiment of support bag 100 is provided which includes an extended top flap 102. FIG. 7a shows insertion of filter bag 30 into outer support bag 100 with filter bag 30 being open at the top to allow depositing of raw shredded or ground produce therein, and FIG. 7b shows where support bag extended top flap 102 may be optionally folded over filter bag 30 so as to completely close the otherwise open top 30′ of filter bag 30 which is located inside outer support bag 100.

As seen in FIGS. 8a-d, Step 1 (FIG. 8a) shows the paper filter bag 30 being inserted into interior “I” of outer support bag 10. Step 2 (FIG. 8b) shows shredded or whole fruit or vegetables (foodstuff) “FS” being loaded into the filter bag 30. Step 3 (FIG. 8c) shows the pressing stage where at least one of the pressing platens P1 and P2 move toward the other and compress everything located therebetween, namely the foodstuff “FS” located in filter bag 30 with juice “J” exiting outer bag 10 through spout 22 as indicated at arrow 24. Step 4 (FIG. 8d) shows the press after it has been opened again (i.e., pressing platens P1 and P2 have been moved away from each other) and the disposable filter bag 30 containing the left over foodstuff cake “FS/C” is lifted out and discarded. Outer bag 30 may then be cleaned and used again with a new disposable bag 30.

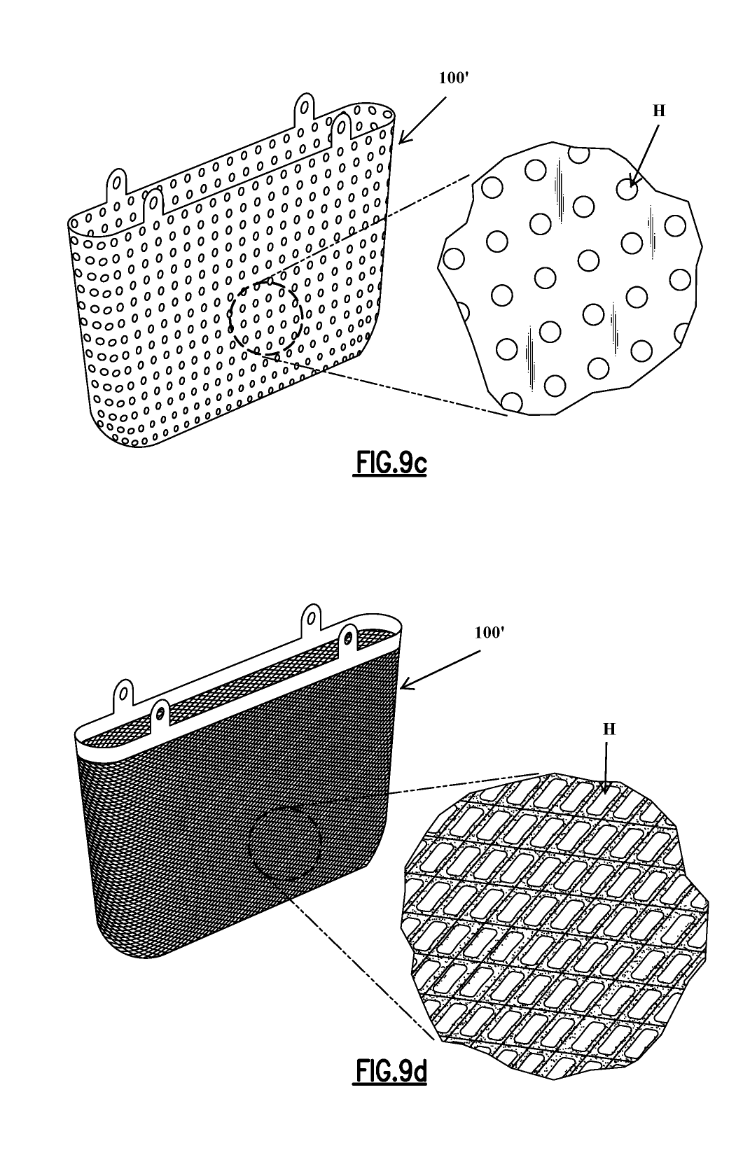

FIGS. 9a-9d illustrate yet a further alternate embodiment of the outer support bag 100′ which includes through holes “H” of any desired shape such as round (FIG. 9c) or rectangular (FIG. 9d), for example, formed in one or more walls thereof and wherethrough juice can exit support bag 100′ as indicated by juice droplets “J”. As such, no outlet such as spout 22 is required at the bottom of the bag but is optionally included if desired. Although not seen in FIGS. 9a-9d, grooves “G” may also be provided on the inwardly facing surfaces of one or more of the outer support bag walls if desired. The plurality of holes “H” and/or grooves “G” allows the juice to exit the outer bag very close to where it is immediately prior to it being pressed. An extended top flap 102′ for closing off inner filter bag 30 is also shown in this embodiment but is likewise optional. The outer support bag may be formed of any desired material including silicone, natural rubber and a metal, for example. Regardless of material from which the outer support bag of made, it is preferred although not absolutely required that there are no undercuts, gaps or other intersections of material which could trap food particles. In this embodiment of the outer bag 100′ having the plurality of holes “H”, the platens P1 and/or P2 preferably include juice directing channels such as grooves “G” on the inwardly facing surfaces thereof (see FIG. 8d) which may be linear as shown or non-linear (e.g., curved or zig-zag).

While the apparatus, methods and systems have been shown and described with reference to certain preferred embodiments thereof, it will be understood by those skilled in the art that various changes in form and details may be made therein without departing from the spirit and scope of the invention as described.

What is claimed is:

1. A reusable, flexible outer support bag for supporting a disposable filter bag removably placed inside said outer support bag during a juice pressing operation which applies pressure against the outer support bag and inner filter bag, said outer support bag having one or more juice outlets whereby juice pressed from a foodstuff located inside said disposable filter bag passes through said filter bag and is directed out of said outer support bag through said one or more juice outlets, said outer support bag providing support to said filter bag and preventing rupture thereof during the application of pressure.

2. The support bag of claim 1 wherein said one or more juice outlets comprise one or more through holes formed in said outer support bag and wherethrough juice may pass from the interior to the exterior of said outer support bag.

3. The support bag of claim 2 wherein said outer support bag includes a bottom wall with at least one of said one or more juice outlets formed therein.

4. The support bag of claim 1 wherein said outer support bag is made from silicone or natural rubber.

5. The support bag of claim 4 wherein said one or more juice outlets comprise one or more through holes formed in said outer support bag and wherethrough juice may pass from the interior to the exterior of said outer support bag.

6. The support bag of claim 1 wherein said outer support bag is made from metal.

7. The support bag of claim 6 wherein said one or more juice outlets comprise one or more through holes formed in said outer support bag and wherethrough juice may pass from the interior to the exterior of said outer support bag.

8. The support bag of claim 1 wherein said outer support bag includes an inner wall surface having one or more grooves formed therein.

9. The support bag of claim 8 wherein said outer support bag includes an upper edge defining an open top and a bottom wall locate opposite said open top, and wherein said one or more grooves extend from a location adjacent said upper edge to a position adjacent said bottom wall.

10. The support bag of claim 9 wherein said at least one juice outlet is located in said bottom wall.

11. The support bag of claim 10 wherein said at least one juice outlet at said bottom wall is in the shape of a funnel.

12. The support bag of claim 9 and further comprising one or more through holes formed in said outer support bag and wherethrough juice may pass from the interior to the exterior of said outer support bag.

13. The support bag of claim 9 wherein said outer support bag is made from silicone rubber.

14. The support bag of claim 8 wherein one or both of said holes and grooves are each about 0.0625 inches wide.

15. The outer support bag of claim 1 wherein said outer support bag includes one or more top flaps configured to fold over said filter bag.

16. A method of pressing juice from a foodstuff, said method comprising the steps of:
a.) providing a reusable, flexible outer support bag having one or more juice outlets;
b.) providing a disposable filter bag and removably placing said disposable filter bag inside said outer support bag with foodstuff located inside said filter bag;
c.) performing a juice pressing operation by applying pressure against the outer support bag and inner filter bag; and
d.) collecting juice pressed from the foodstuff located inside said disposable filter bag, said outer support bag configured to provide support to said filter bag and prevent rupture thereof during the application of pressure.

17. The method of claim 16 and further comprising the step of discarding said filter bag and repeating steps a-d with a new filter bag.

18. The method of claim 17 and further comprising the step of rinsing said outer support bag prior to repeating said steps a-d.

19. The method of claim 16 wherein said application of pressure is performed with at least one platen.

20. The method of claim 19 wherein said method further comprises the steps of providing first and second platens between which said outer support bag is removably positioned, and wherein said application of pressure is performed by at least one of said first and second platens moving against said outer support bag.

21. A system for pressing juice from a foodstuff, said system comprising:
a.) a reusable, flexible outer support bag;
b.) a disposable filter bag configured to be removably placed inside said outer support bag during a juice pressing operation which applies pressure against the outer support bag and inner filter bag, said outer support bag having one or more juice outlets whereby juice pressed from a foodstuff located inside said disposable filter bag passes through said filter bag and is directed out of said outer support bag through said one or more juice outlets, said outer support bag providing support to said filter bag and preventing rupture thereof during the application of pressure.

22. The system of claim 21 wherein said disposable filter bag is made of paper.

23. The system of claim 22 wherein said disposable filter is made from spun polymer.
